(19) United States
(12) Patent Application Publication
(10) Pub. No.: US 2012/0110657 A1
(43) Pub. Date: May 3, 2012

(54) APPARATUS AND METHOD FOR HOST-BASED NETWORK SEPARATION

(75) Inventors: Kyung Wan Kang, Seoul (KR); Kwang Tae Kim, Seoul (KR); Heean Park, Seoul (KR)

(73) Assignee: AHNLAB, INC., Gyeonggi-do (KR)

(21) Appl. No.: 13/383,996

(22) PCT Filed: Jul. 14, 2010
(86) PCT No.: PCT/KR2010/004565

§ 371 Date: Jan. 13, 2012

(30) Foreign Application Priority Data
Jul. 14, 2009 (KR) 10-2009-0064014

(51) Int. Cl. G06F 21/20; G06F 15/16

(52) U.S. Cl. 726/13

(57) ABSTRACT

The invention relates to an apparatus for host-based network separation, comprising: a network separation switch which, when a process is being executed on a host computer, checks whether the network allocated to the process is an internal network or an external network in accordance with the network access authority allocated to the process, and separates the process by IPs allocated to each network; and a packet processor which blocks the access of packet data when the packet data of the process separated by IPs by the network separation switch access a network other than the network to which the relevant IP is allocated.

### FIELD OF THE INVENTION

The present invention relates to network security and, more particularly, to an apparatus and method for host-based network separation, which enable efficient network separation to achieve in a host computer, to which both an internal network used for business and an external network used for access to the Internet are connected, without requiring the construction of an additional network or the installation of an additional server.

### BACKGROUND OF THE INVENTION

In recent years, with the rapid development of computer technology, the extensive use of computers and computer networks has become possible. Public organizations and companies are actively using not only internal networks but also external networks, such as the Internet, in order to conduct research and use e-mail transmission and file transfer to other locations to carry out business.

As external networks which are vulnerable to external attacks, such as attacks over the Internet, are in widespread use, public organizations or companies deploy and operate firewalls to keep important internal information secure. However, such firewalls cannot completely protect important internal information against intentional external attacks because they cannot prevent accesses which bypass them.

Accordingly, recently, a network separation technology has been introduced that separates an internal network and an external network from each other, thereby attempting to protect important information on the internal network against attacks made over the external network.

The network separation technology refers to a technology that constructs a network used for networking using two or more networks that have been physically completely separated based on the purpose they are used for and prevents network packet data from being transferred between the networks, thereby preventing other networks from being damaged even when one network has been infiltrated by hacking or the like.

Recently, although many public organizations and companies are carrying out network separation projects in order to enhance security using the above network separation technology, there arise the problems of incurring expenses and deteriorating efficiency because network separation requires the construction of an additional network and the addition of PCs and servers which can access only the added network, etc.

FIG. 1 is a diagram illustrating the concept of physical network separation in order to increase the understanding of network separation. As shown in FIG. 1, network separation is configured such that a user employs two computer systems to utilize one for an internal network such as a business network, and the other for an external network such as the Internet. As network separation can be physically achieved as described above, packet data cannot be exchanged between the individual networks, and therefore the computer system for the internal network over which important data can be accessed is inaccessible even when the other computer system is infected with malware or has been hacked over the external network, such as the Internet which is comparatively vulnerable to such attacks, thereby enhancing security.

However, the network separation technology such as that shown in FIG. 1 is problematic in that the installation of an additional server is required to support the separate networks and Server-Based Computing (SBC) and in that serviceability is considerably deteriorated because business is conducted on a virtual Personal Computer (PC) of a server which should have significantly lower performance than an individual PC due to the simultaneous use of a plurality of individuals.

### SUMMARY OF THE INVENTION

Accordingly, the present invention provides an apparatus and method for host-based network separation in which a single host computer to which both an internal network used for business and an external network used for access to the Internet are connected, previously allocate a network accessible to each process to the process based on the characteristics of information which can be processed by the process and perform control so that the transmission/reception of data can be performed in connection with the previously allocated network accessible to the process when the process is being executed, thereby enabling network separation to be more efficiently achieved in the single host computer without requiring the construction of an additional network or the installation of an additional server.

In accordance with a first aspect of the present invention, there is provided a host-based network separation apparatus, including:

a network separation switch configured to check whether a network allocated to a process is an internal network or an external network when the process is executed on a host computer, based on an access right to the network previously allocated to the process, to separate the process for an Internet Protocol (IP) address allocated to the internal network or the external network; and

a packet processor configured to block the access in which packet data of the process separated for the IP address by the network separation switch attempts to access another network other than the internal or the external network to which the IP address has been allocated.

In accordance with a second aspect of the present invention, there is provided a host-based network separation apparatus, including:

a network separation switch configured to check whether a network allocated to a process is an internal network or an external network, when the process is executed on a host computer, based on an access right to the network previously allocated to the process, to separate the process for the internal network or the external network;

an internal network packet processor configured to transmit packet data of the process, separated for the internal network by the network separation switch, to the internal network via a first Network Interface Card (NIC) connected to the internal network; and

an external network packet processor configured to transmit packet data of the process, separated for the external network by the network separation switch, to the external network via a second NIC connected to the external network.

In accordance with a third aspect of the present invention, there is provided a host-based network separation apparatus, including:

a virtual environment generation unit configured to check whether a network allocated to a process is an internal network or an external network when the process is executed on a host computer and attempts to access the network, based on an access right to the network previously allocated to the process, generate a virtual work environment in which access to the internal network or the external network is logically separated from each other, and guide the process into the virtual work environment to be executed therein,

a network separation switch configured to check the virtual work environment in which the process has been executed, and separate the process for the internal network or the external network;

an internal network packet processor configured to transmit packet data of the process, separated for the internal network by the network separation switch, to a first Network Interface Card (NIC) connected to the internal network; and

an external network packet processor configured to transmit packet data of the process, separated for the external network by the network separation switch, to a second NIC connected to the external network.

In accordance with a fourth aspect of the present invention, there is provided a host-based network separation method, including:

checking whether a network allocated to a process is an internal network or an external network when the process is executed on a host computer, based on an access right to the network previously allocated to the process, and separating the process for an IP address allocated to each of the internal network and the external network;

checking whether packet data of the process separated for the IP address by the network separation switch attempts to access another network other than the internal or the external network to which the IP address has been allocated;

if, as a result of the checking, the packet data of the process attempts to access the another network, blocking the access; and

if, as a result of the checking, the packet data of the process does not attempt to access the another network, transmitting the packet data to the internal network or the external network, allocated to the process.

In accordance with a fifth aspect of the present invention, there is provided a host-based network separation method, including:

checking whether a network allocated to a process is an internal network or an external network when the process is executed on a host computer, based on an access right to the network previously allocated to the process, and separating the process for the internal network or the external network;

transmitting packet data, resulting from the execution of the process separated for the internal network by the network separation switch, to the internal network via a first Network Interface Card (MC) connected to the internal network; and

transmitting packet data, resulting from the process separated for the external network by the network separation switch, to the external network via a second NIC connected to the external network.

In accordance with a sixth aspect of the present invention, there is provided a host-based network separation method, including:

checking whether a network allocated to a process is an internal network or an external network when the process is executed on a host computer and attempts to access the network, based on an access right to the network previously allocated to the process, and generating a virtual work environment in which access to the internal network or the external network is logically separated from each other;

guiding the process into the virtual work environment to be executed therein;

checking the virtual work environment in which the process has been executed, and allocating separately the process to the internal network or the external network; and

transmitting packet data resulting from the execution of the process to the internal network or the external network allocated to the process.

In accordance with the present invention, in the host-based network separation method, when a process which is executed in a single host computer system attempts to use a network, such as the internal or external network connected to the host computer system, the network separation switch guides a connection to the internal or external network consistent with an access right to the network previously allocated to the process, and packet data resulting from the execution of the process is transmitted to the internal network or the external network via the packet processor, without affecting the host computer system or directly manipulating the process, thereby achieving the advantage of enabling logical network separation to be more efficiently achieved in the single host computer system.

### BRIEF DESCRIPTION OF THE DRAWINGS

FIG. 1 is a diagram of illustrating the concept of network separation;

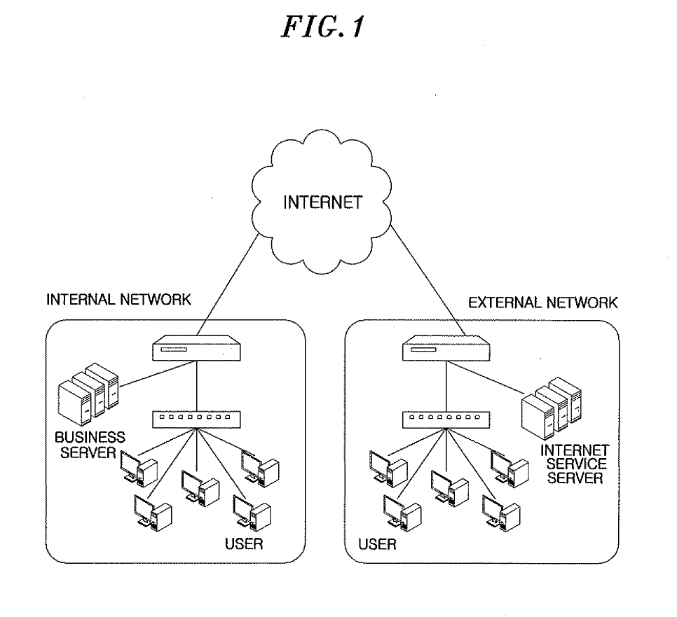

FIG. 2 shows a block diagram of illustrating the concept of host-based network separation in accordance with an embodiment of the present invention;

FIG. 3 shows a block diagram of illustrating the concept of host-based network separation in physically separate networks in accordance with another embodiment of the present invention; and

FIG. 4 shows a block diagram of illustrating the concept of host-based network separation using a virtual environment in accordance with another embodiment of the present invention.

### DETAILED DESCRIPTION OF THE EMBODIMENTS

The operating principles of the present invention will be described in detail below with reference to the accompanying drawings. In the following description, if detailed descriptions of well-known constructions or functions are determined to make the gist of the present invention vague, the detailed descriptions will be omitted. The following terms have been defined in light of their functions in the present invention. Since the meanings of the terms may vary according to a user's or an operator's intention or usual practice, the meanings of the terms must be interpreted based on the overall context of the present specification.

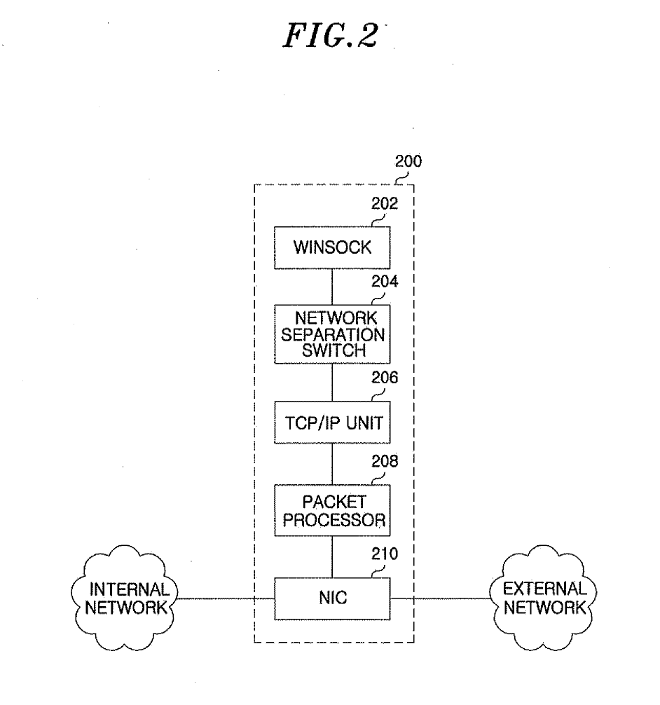

FIG. 2 is a block diagram of showing the concept of host-based network separation in accordance with an embodiment of the present invention and illustrates the concept of logical network separation in which an internal network and an external network are connected to a host computer 200 as a single physical network.

Referring to FIG. 2, a host-based network separation apparatus includes a network separation switch 204, a packet processor 208, and a network interface card (NIC) 210.

First, a Winsock (Windows socket) 202 defines Application Programming Interface (API) for a communication method and a communication function which are used in an application program to perform communication.

The network separation switch 204, when a process is executed on the host computer 200, checks whether a network allocated to the process is the internal network or the external network to separate the process for an Internet Protocol (IP) address allocated to each of the internal and the external networks. In order to support logical network separation, the host computer 200 to which both the internal and the external networks are connected is allocated two different IP addresses used for the connection with the internal network or the external network. The network separation switch 204 identifies the internal network or the external network, allocated to the process, using the IP information. Furthermore, in this case, the process is previously assigned access right to network in accordance with the policy based on the characteristics of information to be processed so that it can access the internal network or the external network, and the network separation switch 204 can check whether a network allocated to the process is the internal network or the external network based on the allocated network access right.

A Transmission Control Protocol/Internet Protocol (TCP/IP) unit 206 performs the retransmission of an error frame via flow control using a window algorithm when data is transmitted based on TCP/IP.

The packet processor 208 checks whether there is an attempt to gain access to another network to which the right to gain access have not been allocated with respect to packet data resulting from the execution of the process separated by the network separation switch 204. If there is no attempt to gain access to another network, the packet processor 208 then transmits the packet data to the allocated internal or external network via the NIC 210. However; if there is an attempt to gain access to another network, the packet processor 208 then transmits blocks the attempt to gain access to another network.

The NIC 210 is a device which is connected to the internal network or the external network and performs interfacing on data transmitted and received between the host computer 200 and the internal and the external networks. The NIC 210 transmits packet data from the packet processor 208 to the internal network or the external network allocated to the process.

As described above, the host computer 200 is allowed to use two different IP addresses which enable separate connections to the internal and external networks, thereby enabling a single physical network to be used as if it were two separate networks.

That is, a process which is executed on the host computer 200 is guided to access to the internal network or the external network selectively and previously allocated by the network separation switch 204, and packet data resulting from the execution of the process is identified by the packet processor 208 based on the access right to network granted to the process, and is allowed to be transmitted to the internal network or the external network, previously allocated to the process, via the NIC 210, thereby enabling a single physical network to be used as if it were two networks which are logically separated from each other.

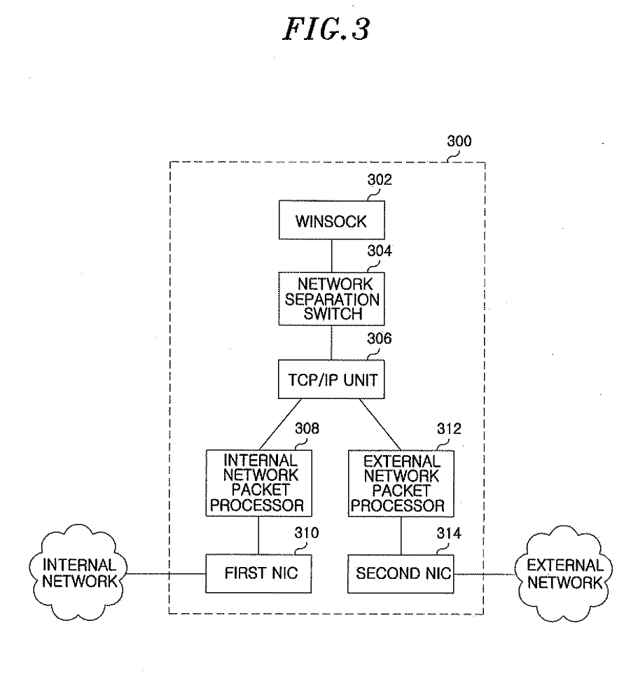

FIG. 3 is a block diagram of showing the concept of host-based network separation in accordance with another embodiment of the present invention, and illustrates the concept of network separation in the case where an internal network and an external network are connected to a host computer 300 as separate physical networks.

Referring to FIG. 3, a host-based network separation apparatus includes a network separation switch 304, an internal network packet processor 308, an external network packet processor 312, a first MC 310 connected to the internal network, and a second NIC 314 connected to the external network.

First, a Winsock 302 defines API for a communication method and a communication function which are used in an application program to perform communication.

The network separation switch 304, when a process is executed on the host computer 300, checks if a network allocated to the process is the internal network or the external network to separate the process for the allocated network. In this case, the process is previously assigned access right to a network in accordance with a policy based on the characteristics of the information to be processed so that it can access the internal network or the external network. Therefore, the network separation switch 304 can check whether a network allocated to the process is the internal network or the external network based on the allocated network access right. A TCP/IP unit 306 performs the retransmission of an error frame via a flow control using a window algorithm when data is transmitted using TCP/IP.

The internal network packet processor 308 transmits the packet data of the process, separated for the internal network by the network separation switch 304, to the internal network via the first MC 310 connected to the internal network.

The external network packet processor 312 transmits the packet data of the process, separated for the external network by the network separation switch 304, to the external network via the second NIC 314 connected to the external network.

That is, as illustrated in FIG. 3 the internal and the external networks are constructed to be separated in the host computer 300, and each process is allocated either the internal network or the external network in advance. When a process is executed, packet data resulting from the execution of the process is separated and transmitted to the internal network or the external network via the NIC connected to the internal network or the external network allocated to the process.

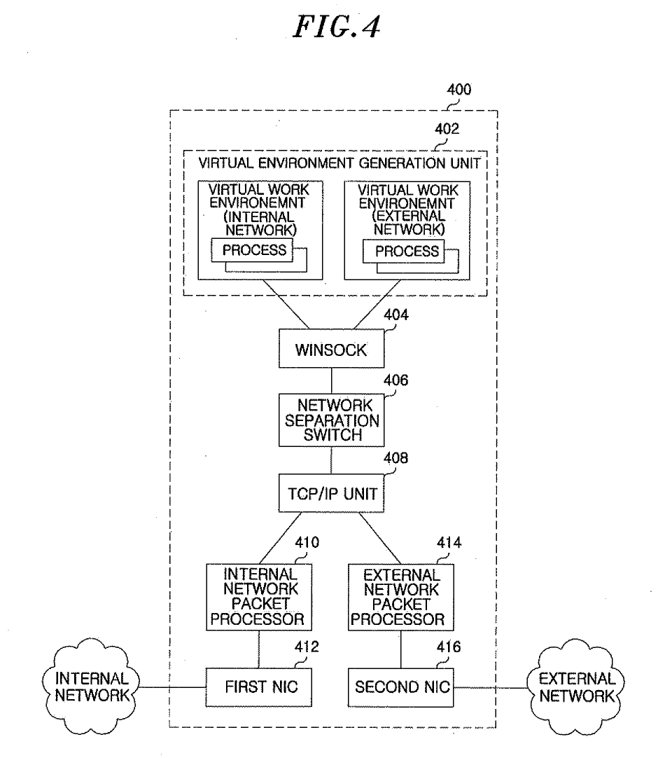

FIG. 4 is a block diagram of showing the concept of host-based network separation in accordance with another embodiment of the present invention, and illustrates the concept of network separation based on the generation of a virtual work environment for each process in the case where an internal network and an external network are connected to a host computer 400 as separate physical networks.

Referring to FIG. 4, a host-based network separation apparatus includes a virtual environment generation unit 402, a network separation switch 406, an internal network packet processor 410, an external network packet processor 414, a first NIC 412 connected to the internal network, and a second NIC 416 connected to the external network.

First, a Winsock 404 defines API for a communication method and a communication function which are used in an application program to perform communication.

The virtual environment generation unit 402, when a process is executed on a host computer 400 and attempts to gain access to a network, checks whether a network allocated to the process is the internal network or the external network based on a network access right of the process provided upon the execution of the process, and generates a virtual work environment in which access to the internal network or the external network is logically separated from each other. In this case, the process has a previously assigned network access right in accordance with a policy based on the characteristics of information to be processed so that it can access the internal or external network, and therefore, it is possible to check whether the network allocated to the process is the internal or external network based on the allocated network access right. Therefore, when a process is executed, the process is guided to and then executed in a virtual work environment allocated to the process.

The network separation switch 406 checks the virtual work environment in which the process has been executed, and separates the process for the internal network or the external network corresponding to the virtual work environment. A TCP/IP unit 408 performs the retransmission of an error frame and the like via a flow control using a window algorithm when data is transmitted based on TCP/IP.

The internal network packet processor 410 transmits packet data, resulting from the execution of the process, to the internal network via the first NIC 412 connected to the internal network, in case where the process is separated for the internal network by the network separation switch 406 based on the virtual work environment in which the network separation has been executed.

The external network packet processor 414 transmits packet data, resulting from the execution of the process, to the external network via the second NIC 416 connected to the external network, in case where the process is separated for the external network by the network separation switch 406 based on a virtual environment in which the network separation process has been executed.

Meanwhile, the internal network packet processor 410 and the external network packet processor 414, when the internal or the external network connected to the host computer 400 employs a Virtual Local Area Network (VLAN), insert a VLAN tag, recognizable by the VLAN, into packet data and then transmit the packet data.

That is, as illustrated in FIG. 4 in which the internal and the external networks are constructed to be physically separated in the host computer 400, the internal or the external network to be allocated to a process is previously set, and, when the process is executed, a virtual work environment connected to the internal or the external network on the computer is generated, and the process is guided to the generated virtual work environment to be connected to the internal or external network previously allocated to the process, thereby rendering it possible to block access from another network.

As described above, in accordance with the present invention, in the host-based network separation method, when a process which is executed in the host computer system attempts to use a network such as an internal or an external network connected to the host computer system, the network separation switch guides a connection to the internal or the external network consistent with the right to use the network previously allocated to the process, and packet data resulting from the execution of the process is caused to be transmitted to the corresponding internal network or the corresponding external network via the packet processor, without affecting the host computer system or directly manipulating the process, thereby achieving the advantage of enabling logical network separation to be more efficiently achieved in a single host computer system.

Although the specific embodiments have been described in the above description of the present invention, a variety of variations may be practiced without departing from the scope of the present invention. Accordingly, the scope of the invention should not be defined by the described embodiments, but should be defined by the claims.

What is claimed is:

1. A host-based network separation apparatus, comprising:
a network separation switch configured to check whether a network allocated to a process is an internal network or an external network when the process is executed on a host computer, based on an access right to the network previously allocated to the process, to separate the process for an Internet Protocol (IP) address allocated to the internal network or the external network; and
a packet processor configured to block the access in which packet data of the process separated for the IP address by the network separation switch attempts to access another network other than the internal or the external network to which the IP address has been allocated.

2. The host-based network separation apparatus of claim 1, wherein the host computer has two different IP addresses which are selectively used to connect to the internal or the external network.

3. The host-based network separation apparatus of claim 1, wherein the process is previously allocated the access right to the network in accordance with a policy based on characteristics of information to be processed by the process so that the process can access the internal network or the external network.

4. The host-based network separation apparatus of claim 1, wherein the internal and external networks are constructed as a single network and are connected to the host computer.

5. The host-based network separation apparatus of claim 1, wherein the external network is the Internet.

6. A host-based network separation apparatus, comprising:
a network separation switch configured to check whether a network allocated to a process is an internal network or an external network, when the process is executed on a host computer, based on an access right to the network previously allocated to the process, to separate the process for the internal network or the external network;
an internal network packet processor configured to transmit packet data of the process, separated for the internal network by the network separation switch, to the internal network via a first Network Interface Card (NIC) connected to the internal network; and
an external network packet processor configured to transmit packet data of the process, separated for the external network by the network separation switch, to the external network via a second NIC connected to the external network.

7. The host-based network separation apparatus of claim 6, wherein the internal network packet processor, when packet data of the process allocated to the internal network to which access is not allowed in accordance with the policy attempts to access the external network, blocks the access to the external network, while allowing the transfer of the packet data to the internal network.

8. The host-based network separation apparatus of claim 6, wherein the external network packet processor, when packet data of the process allocated to the external network to which access is not allowed in accordance with the policy attempts to access the internal network, blocks the access to the internal network, while allowing the transfer of the packet data to the external network.

9. The host-based network separation apparatus of claim 6, wherein the process is previously allocated the access right to the internal network or the external network in accordance with the policy based on characteristics of information to be processed by the process so that the process can access the internal network or the external network.

10. The host-based network separation apparatus of claim 6, wherein the internal and the external networks are respectively constructed as physically separate networks and are connected to the host computer.

11. The host-based network separation apparatus of claim 6, wherein the external network is the Internet.

12. A host-based network separation apparatus, comprising:
a virtual environment generation unit configured to check whether a network allocated to a process is an internal network or an external network when the process is executed on a host computer and attempts to access the network, based on an access right to the network previously allocated to the process, generate a virtual work environment in which access to the internal network or the external network is logically separated from each other, and guide the process into the virtual work environment to be executed therein,
a network separation switch configured to check the virtual work environment in which the process has been executed, and separate the process for the internal network or the external network;
an internal network packet processor configured to transmit packet data of the process, separated for the internal network by the network separation switch, to a first Network Interface Card (NIC) connected to the internal network; and
an external network packet processor configured to transmit packet data of the process, separated for the external network by the network separation switch, to a second NIC connected to the external network.

13. The host-based network separation apparatus of claim 12, wherein the process is previously allocated the access right to the network in accordance with a policy based on characteristics of information to be processed by the process so that the process can access the internal network or the external network.

14. The host-based network separation apparatus of claim 12, wherein the internal network and the external network are respectively constructed as physically separate networks and are connected to the host computer.

15. The host-based network separation apparatus of claim 12, wherein the external network is the Internet.

16. A host-based network separation method, comprising:
checking whether a network allocated to a process is an internal network or an external network when the process is executed on a host computer, based on an access right to the network previously allocated to the process, and separating the process for an IP address allocated to each of the internal network and the external network;
checking whether packet data of the process separated for the IP address by the network separation switch attempts to access another network other than the internal or the external network to which the IP address has been allocated;
if, as a result of the checking, the packet data of the process attempts to access the another network, blocking the access; and
if, as a result of the checking, the packet data of the process does not attempt to access the another network, transmitting the packet data to the internal network or the external network, allocated to the process.

17. The host-based network separation method of claim 16, wherein the internal network and the external network are constructed as a single network and are selectively connected to the host computer via two different IP addresses allocated to the host computer.

18. The host-based network separation method of claim 16, wherein the process is previously allocated the access right to the network in accordance with a policy based on characteristics of information to be processed by the process so that the process can access the internal network or the external network.

19. The host-based network separation method of claim 16, wherein the external network is the Internet.

20. A host-based network separation method, comprising:
checking whether a network allocated to a process is an internal network or an external network when the process is executed on a host computer, based on an access right to the network previously allocated to the process, and separating the process for the internal network or the external network;
transmitting packet data, resulting from the execution of the process separated for the internal network by the network separation switch, to the internal network via a first Network Interface Card (NIC) connected to the internal network; and
transmitting packet data, resulting from the process separated for the external network by the network separation switch, to the external network via a second NIC connected to the external network.

21. The host-based network separation method of claim 20, wherein the internal network and the external network are respectively constructed as physically separate networks and are connected to the host computer.

22. The host-based network separation method of claim 20, wherein the first NIC and the second NIC are provided in the host computer, and are respectively connected to the internal network and the external network.

23. A host-based network separation method, comprising:
checking whether a network allocated to a process is an internal network or an external network when the process is executed on a host computer and attempts to access the network, based on an access right to the network previously allocated to the process, and generating a virtual work environment in which access to the internal network or the external network is logically separated from each other;
guiding the process into the virtual work environment to be executed therein;
checking the virtual work environment in which the process has been executed, and allocating separately the process to the internal network or the external network; and
transmitting packet data resulting from the execution of the process to the internal network or the external network allocated to the process.

24. The host-based network separation method of claim 23, wherein said transmitting packet data comprises:
checking a network to which the packet data resulting from the execution of the process attempts to access;
if the network to which the packet data attempts to access is not a network connected to the virtual work environment of the process, blocking the packet data from accessing the network; and
if the network which the packet data attempts to access is a network connected to the virtual work environment of the process, transmitting the packet data to the internal network or the external network allocated to the process.

25. The host-based network separation method of claim 23, wherein said transmitting packet data comprises:
if the internal network or the external network to which the packet data is transmitted utilizes a Virtual Local Area Network (VLAN), inserting a VLAN tag, recognizable in the VLAN, into the packet data and then transmitting the packet data.

26. The host-based network separation method of claim 23, wherein the process is previously allocated the access right to the network in accordance with a policy based on characteristics of information to be processed by the process so that the process can access the internal network or the external network.

27. The host-based network separation method of claim 23, wherein the internal and the external networks are respectively constructed as physically separate networks and are connected to the host computer.

28. The host-based network separation method of claim 23, wherein the transmitting the packet data comprises:
transmitting the packet data to the internal network or the external network via one of network interface cards provided in the host computer and respectively connected to the internal network and the external network.
